(19) United States
(12) Patent Application Publication
(10) Pub. No.: US 2011/0271652 A1
(43) Pub. Date: Nov. 10, 2011

(54) Protective Boot for Livestock

(76) Inventor: Janet Amy Wollowick, Hollywood, FL (US)

(21) Appl. No.: 12/773,563

(22) Filed: May 4, 2010

(51) Int. Cl. B68C 5/00

(52) U.S. Cl. 54/82

(57) ABSTRACT

A protective boot useful for protecting the legs and hoofs of livestock. The protective boot can have a legging member and a shoe member. The legging member can be made of a durable fabric and fastened together around the leg of livestock with a fastening device. The shoe member can be made of a durable fabric or more rigid material with a cushioned bottom portion. The cushioned bottom portion can include a gel pad that is soft, supportive, and durable. The shoe member may be custom-fitted to a particular animal's hoof or to each of the animal's hooves. The cushioned bottom portion can protect the hoof of the animal from impact injuries caused by locomotion across various surface types. The legging member and shoe member of the protective boot may be separated by unfastening the fastener connecting them.

### FIELD OF THE INVENTION

The invention relates to livestock. More particularly, the invention relates to a protective apparatus that can be worn over and around the hoof and leg of a livestock animal.

### BACKGROUND

Horses and other livestock animals often suffer from injury and stress to their hooves and legs. Physical injuries occur as the animals walk and run. Injuries may be caused by the repeated forceful impact of the animal's hoof on dirt, pavement, rock, or other surfaces on which the animal ambulates. Treatment of leg and hoof injuries can be costly for the owner and may lead to more serious illness or death of the animal. Such injuries are particularly problematic in the cases of race horses and show horses, which may be bred to have thinner leg bones that are more easily broken or subject to injuries such as stress fractures. In an effort to protect from these injuries, leggings have been provided for horses to stabilize their legs during movement. Conventional leggings can be cumbersome and uncomfortable for the horse or other livestock to wear. Because existing leggings are uncomfortable for the animal, ointments and liniments are often used to protect and insulate the animal's legs. A livestock animal's leg that is kept warm will be less susceptible to injuries as the muscles in the leg will be loose. Ointments and liniments, however, can be messy and difficult to clean off of the animal's legs.

Leggings provide support for the animal's legs, but do not support or protect the animal's hooves. Certain manmade substrates on which livestock animals walk such as, for example, wood, concrete or asphalt, may increase the likelihood of injury to an animal. Because these substrates may be slippery and are not soft and do not yield like a natural substrate such as grass, dirt, or clay, a horse or other livestock animal may suffer from injuries to its joints, hooves, and leg bones. With the exception of horseshoes for horses, currently, existing products are not useful for the protection of the hoof. Existing livestock products do not provide cushioning to the step of the horse or other livestock animal and do not protect any other part of the hoof. Such protection of the hoof, and particularly of the bottom of the hoof, is important especially during transport of the animal as well as during routine activities. Providing protection to the hooves of horses and other livestock animals will further protect these animals from injury while walking and running but may be removed when the animal is racing or performing another task expected of it.

### SUMMARY

A protective boot is provided that features a legging member and a shoe member. The protective boot can be used by a consumer to provide for protection for a livestock animal's legs and hooves. The shoe member can be fitted over and fastened around an animal's hoof. Once the shoe member is fitted over the hoof, the animal's leg can be wrapped with the legging member. The legging member can be detachably connected to the shoe member using one or more fasteners. The protective boot can be used fitted over and around the legs and hooves of animals being transported or it can be worn by animals engaged in routine daily activities. The protective boot can be constructed from a variety of durable fabrics. The shoe member may be manufactured from the same fabric as the legging member or it may be made from a more rigid material. Neoprene is one example of a durable fabric that may be used in the construction of the protective boot.

The legging member can be secured on the leg of an animal. The legging member can feature an elastic band or other tightening means (e.g., a drawstring), either at the top or bottom, or both. The elastic band can help to secure the legging member snugly around the leg of the livestock animal. In an exemplary embodiment, the legging member is separate and distinct from, but is detachably connectable to, the shoe member. This construction can allow the animal's leg to be placed into the shoe member before securing the legging member around the animal's leg. The legging member may also feature one or more suitable fastening devices to connect two side edges of the legging member around the leg.

The shoe member can be connected to a bottom edge of the legging member to allow for the insertion of a livestock animal's hoof. The shoe member may be constructed from the same material as the legging portion or a more rigid material to handle the rigors of being walked upon. The shoe member may be custom-fit to the hoof of an individual livestock animal to provide the most comfortable and complete fit. The shoe member may also feature a cushioned bottom portion. This may be fit into the frog of the hoof or on the entire bottom surface area of the hoof. The cushioned bottom may be constructed of a durable gel that could be pre-sized or custom-fitted for each hoof of each animal. In the pre-sized embodiment, the cushioned bottom may be constructed in various sizes and may be connected to the bottom portion of the shoe member at some alternative time during the manufacturing process. In the custom-fit embodiment, the cushioned bottom may be shaped and sized in various orientations to best fit the uses of the animal's owner.

The protective boot can also include a means of separating the differing sections. The legging member and the shoe member can be two separate and distinct pieces or may be a single combined and unitary piece. A fastening device, for example, a zipper, may allow the legging member and shoe member to be separated. The detachable two-piece configuration can allow the protective boot to be utilized in three unique ways: (1) as a unitary protective boot including both the legging member and the shoe member, (2) as a legging member alone, and (3) as a shoe member alone. The livestock owner is provided more flexibility in the application and use of the protective boot and is given the freedom to determine the applicability of the protective boot to satisfy the owner's needs.

One advantage of the protective boot is the protection afforded to the livestock animal's leg. During transportation and normal activities, livestock can suffer injuries by striking their legs on objects as well as during locomotion. The legging member can protect the animal's leg from any injury resulting from striking a hard surface such as, for example, the edge of a trailer used in transporting livestock when the livestock is entering or exiting such trailer.

Another advantage of the protective boot is that the cushioned support in the protective boot can absorb the shock associated with hard surfaces with which an animal has contact. Animals are commonly required to traverse different surface substrates that can place varying degrees of stress on the hoof of the animal. The animal's hoof provides minimal cushioning and support, and the shocks resulting from each step by the animal can travel up the animal's leg causing leg injuries in addition to hoof injuries. The cushioned portion of the protective boot's shoe member can soften this impact and allow the livestock animal to comfortably walk across a variety of surface types. The likelihood that the animal suffers from discomfort, fatigue, or stress induced by locomotion across any such surface type can be reduced by using the protective boot.

Still another advantage of the protective boot is the ability to separate the parts. The animal's owner or trainer may want to use the protective boot in a variety of ways to meet a variety of purposes. The detachable two-piece construction of the protective boot, which allows separation of the legging and shoe members, permit configuration of the protective boot to be changed as needed. For example, the configuration and use of the protective boot may be different for each leg of the animal. In one example, the owner may want to use the cushioned shoe members on all four legs, but may desire to use the legging member only on the animal's front legs to protect them during transport. The configuration possibilities allow the owner the freedom to determine what is best.

Yet another advantage of the protective boot is the ability to keep the animal's leg warm. Livestock can be injured when the muscle is cold after prolonged standing periods when the animal is stationary. The legging member can assist in retaining heat in the animal's leg muscle, thereby keeping the animal's leg warm, when wrapped around the leg. The material from which the legging member is constructed can be insulative in nature or additional insulation may be attached to an inner surface of the legging member. By warming the leg with a legging member, the use of ointments or liniments to keep the leg warm can be reduced or minimized. These ointments require continued application in order to keep the leg warm, while the protective boot can provide warmth on a continuous level once fastened to the leg of the livestock animal.

Accordingly, the invention features an apparatus for protecting and supporting an animal's leg and foot. The apparatus can include a protective boot that has a legging member and a shoe member capable of being fitted over a hoof of the animal.

In another aspect, the invention can feature the animal being a livestock animal such as, for example, a horse or a cow.

In another aspect, the invention can feature the protective boot being constructed from fabric.

In another aspect, the invention can feature the fabric being neoprene.

In another aspect, the invention can feature the legging member including a top portion, a bottom portion, a first edge, and a second edge opposite to the first edge.

In another aspect, the invention can feature the legging member and the shoe member being attached together by a fastener.

In another aspect, the invention can feature the legging member being detachable from the shoe member.

In another aspect, the invention can feature the top portion of the legging member including a first elastic band.

In another aspect, the invention can feature the bottom portion of the legging member including a second elastic band.

In another aspect, the invention can feature at least one of the first edge and the second edge including a fastener for connecting one edge to the other edge.

In another aspect, the invention can feature the fastener including at least one fastener selected from among the following: a plurality of snap buttons, a zipper, hook-and-loop fasteners, and at least one buckle.

In another aspect, the invention can feature the shoe member including a material that is more rigid than a material from which the legging member is constructed.

In another aspect, the invention can feature the shoe member including a partially enclosed interior portion and a bottom portion.

In another aspect, the invention can feature the bottom portion of the shoe member including a cushion.

In another aspect, the invention can feature the cushion of the protective boot further including a gel pad.

In another aspect, the invention can feature the gel pad being shaped and sized to fit within a frog of a horse's hoof.

In another aspect, the invention can feature an inner surface of the protective boot including an insulative material.

In another aspect, the invention can feature an inner surface of the protective boot including a cushion material.

In another aspect, the invention can feature the cushion material being selected from among: one or more air-filled bladders, one or more gel-filled bladders, one or more liquid-filled bladders, one or more inner layers of soft material attached to an inner surface of the legging member baffling, and baffling interconnected between an inner surface of the legging member and an layer of material connected to the inner surface of the legging member.

A method of the invention can be used to protect and support an animal leg and foot. The method can include the steps of: (a) inserting the foot of the animal into a shoe member; (b) covering the leg of the animal with a legging member; and (c) detachably connecting the legging member to the shoe member using a fastener.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a side view of a protective boot for livestock secured around a horse leg.

FIG. 2 is a front elevational view of the protective boot of FIG. 1 secured around the horse leg.

FIG. 3 is a top plan view of a legging member of the protective boot of FIG. 1.

FIG. 4 is a side view of a shoe member of the protective boot of FIG. 1.

FIG. 5 is a side view of another embodiment of a shoe member of a protective boot.

FIG. 6 is a side view of one edge of a legging member of a protective boot.

### DETAILED DESCRIPTION

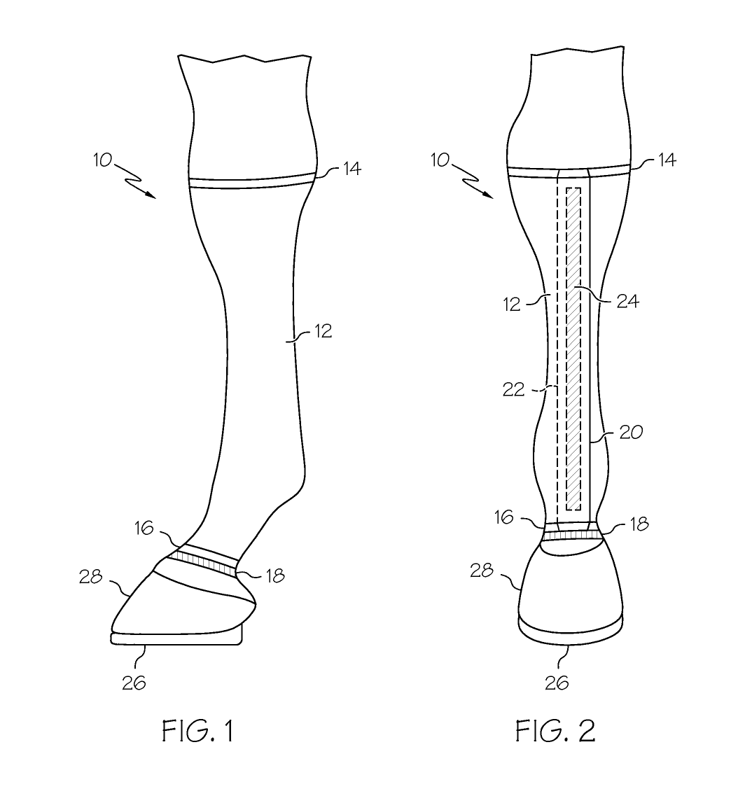

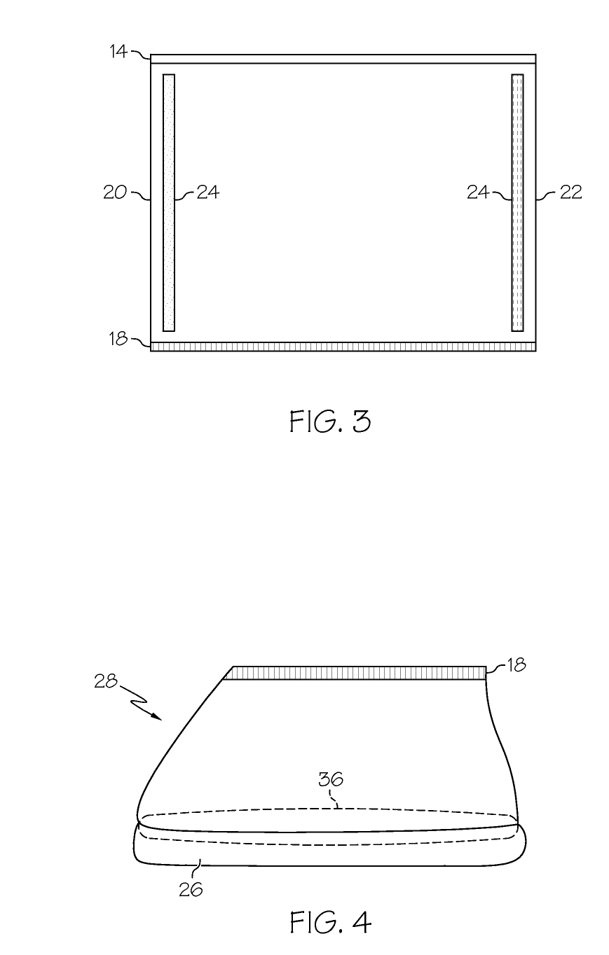

FIGS. 1-4 illustrate a protective boot 10 for protecting and supporting an animal leg and hoof. While various embodiments of the protective boot 10 can be used with almost any animal having legs and feet, the apparatus is ideal for protecting and supporting the legs and feet of livestock animals and of horses in particular. For purposes of example only and not by way of limitation, the invention is described hereinafter in its use with a horse.

The protective boot 10 can include a legging member 12 and a shoe member 28. The shoe member 28 can feature a bottom portion 26, at least one side wall attached to the bottom portion, inner and outer surfaces, and an open end. The open end can be opposite to the bottom portion 26. The side wall of the shoe member 28 can include first and second opposing edges and one or more fasteners 24. The fasteners can be used to connect the first and second opposing edges of the shoe member to one another so as to firmly and snugly fit the shoe member around a horse's hoof. In an exemplary embodiment, the fasteners can be patches of hook and loop fasteners 24a and 24b. In other embodiments, suitable fasteners that may be attached to and used to secure the shoe member around the hoof can include adhesives, buckles, buttons, clips, clasps, hook and eye fasteners, magnetic snaps, safety pins, snap fasteners, ties, and zippers.

In one embodiment, the shoe member 28 may be constructed so that the first and second opposing edges overlap one another when fastened together. In another embodiment, the shoe member 28 may be constructed so that the first and second opposing edges are arranged in adjacent contact with one another when fastened together.

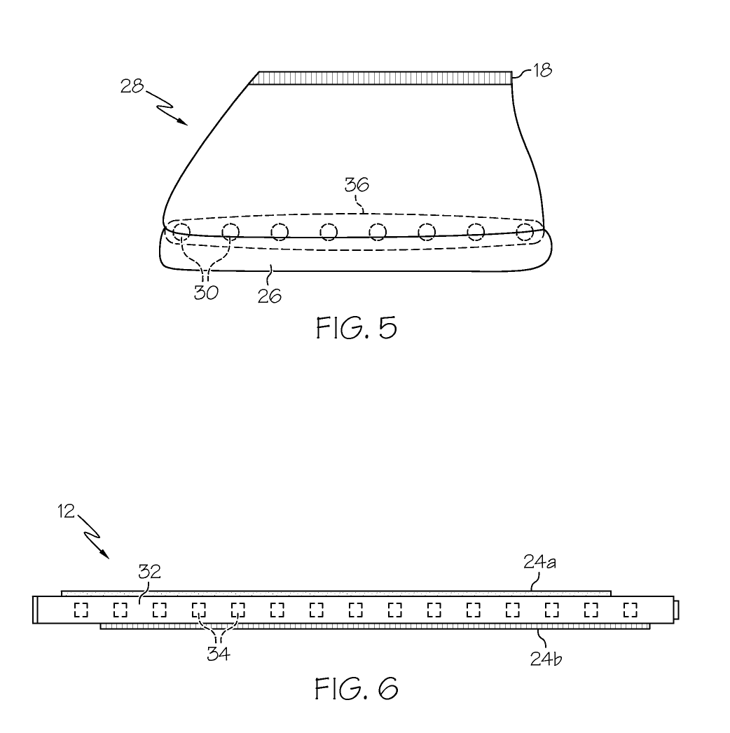

As shown in FIG. 5, the shoe member 28 can feature a cushion 36 such as, for example, a gel pad, attached to the bottom portion 26. The gel pad can provide a cushioning effect as the horse walks across surfaces and across surfaces having hard substrates in particular. The protective cushion 36 can be manufactured from any soft, durable gel. In one embodiment, the protective cushion can feature a lip that projects upwards from the bottom portion of the shoe member onto and over the visible edges of the hoof. In one embodiment, the gel pad lip can extend far enough vertically to envelope and cushion the animal's entire hoof. In an exemplary embodiment, protective boots can be worn on all four hooves of the livestock animal.

The protective cushion 36 can be custom-fitted to fit in the frog of a particular livestock animal's hoof. The protective cushion 36 can also have a baffle 30 in the interior of the gel. The baffle can be a plate, wall, or screen, and may regulate the flow of the gel. The baffle can also provide additional support for absorbing the weight of the animal's body during locomotion when the animal's hoof contacts a substrate. In another embodiment, the protective cushion can be form-fitted to the entire bottom of the hoof. In yet another embodiment, the cushion can extend over the entire shoe member and not just on the bottom portion.

The shoe member 28 can be made of a durable material such as a fabric or a polymer. The material may be rigid. In one embodiment, the material of the shoe member is more rigid than the material from which the legging member is constructed. In exemplary embodiments, the material from which the shoe member is constructed can be breathable and waterproof. In one exemplary embodiment, the material can be neoprene. The shoe member can feature additional cushioning on an inner surface. Cushioning that may be attached to the shoe member's inner surface include one or more air-filled bladders, one or more gel-filled bladders, one or more liquid-filled bladders, one or more inner layers of soft material attached to an inner surface of the shoe member baffling, and baffling interconnected between an inner surface of the shoe member and an layer of material connected to the inner surface of the shoe member. These types of materials and construction may also be attached to the shoe member's inner surface to provide insulation to the shoe member, and thus, to the animal's hoof when worn.

The legging member 12 can feature a sheet of material having first and second opposing edges 20 and 22 and top and bottom edges. The first and second opposing edges 20 and 22 can remain open upon insertion of the hoof into the shoe member 28. The first and second opposing edges 20 and 22 of the legging member 12 can be wrapped around the animal's leg to secure the legging member to and around the leg. The first and second opposing edges 20 and 22 can then be connected together securely by fasteners 24. In an exemplary embodiment, the legging member fasteners 24 can be patches of hook and loop fasteners 24a and 24b. In other embodiments, suitable fasteners 24 that may be attached to and used to secure the legging member 12 around the animal's leg can include adhesives, buckles, buttons, clips, clasps, hook and eye fasteners, magnetic snaps, safety pins, snap fasteners, ties, and zippers.

In one embodiment, the protective boot's legging member 12 may include an upper elastic band 14 at or near the top edge of the fabric so as to provide more support to the legging member when it is secured around the animal's leg. Legging members can be manufactured with bands of various sizes constructed to fit animal legs of various sizes.

In another embodiment, the protective boot's legging member 12 may also include a lower elastic band 16 at or near the bottom edge of the legging member. The lower elastic band 16 can also provide additional support to the legging member 12 and may provides a snugger fit to prevent heat from escaping the legging member. Like the upper elastic band 14, the lower elastic band 16 can also be manufactured in various sizes constructed to fit animal legs of various sizes.

In an exemplary embodiment, the legging member 12 can include both upper and lower elastic bands 14 and 16.

In one embodiment, the legging member 12 can be constructed so that the first and second opposing edges 20 and 22 overlap one another when fastened together. In another embodiment, the legging member 12 can be constructed so that the first and second opposing edges 20 and 22 are arranged in adjacent contact with one another when fastened together.

Fasteners can also be used to connect the first and second opposing edges of the shoe member 28 to one another so as to firmly and snugly fit the shoe member around a horse's hoof. In an exemplary embodiment, the fasteners can be patches of hook and loop fasteners. In other embodiments, suitable fasteners that may be attached to and used to secure the shoe member around the hoof can include adhesives, buckles, buttons, clips, clasps, hook and eye fasteners, magnetic snaps, safety pins, snap fasteners, ties, and zippers.

The legging member 12 can be made of a durable material such as a fabric or a polymer. In exemplary embodiments, the material from which the legging member 12 is constructed can be breathable and waterproof. In one exemplary embodiment, the material can be neoprene. The legging member 12 can feature additional cushioning on an inner surface. As shown in FIG. 6, cushioning 34 that may be attached to the legging member's inner surface include one or more bladders that can be air-filled, gel-filled, or other liquid-filled, one or more inner layers of soft material attached to an inner surface of the legging member baffling, and baffling interconnected between an inner surface of the legging member and a layer of material connected to the inner surface of the legging member. The cushioning can be installed on an inner surface of the legging member. In another embodiment, the cushioning can be internal so that it is positioned between the inner surface and an outer surface of the legging member. In embodiments having bladders for cushioning, the bladders may be separated by baffles 32. These types of materials and construction may also be attached to the legging member's inner surface to provide insulation to the legging member, and thus, to the animal's leg when worn.

In an exemplary use of the invention, all four of an animal's legs can be inserted into and protected by protective boots. Four protective boots may be used with each animal. Two-piece protective boots having separable legging and shoe members may also be constructed for wearing by humans and other bipedal animals.

The invention also features a method for protecting the leg and hoof of a livestock animal. The method can include the steps of inserting the foot of the animal into a shoe member such as the ones described herein, covering the leg of the animal with a legging member such as the ones described herein, and detachably connecting the legging member to the shoe member using a fastener. Methods of the invention may also use the protective boot described herein and the foregoing steps to provide warmth, insulation, and cushioning to an animal's leg, hoof, or both.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An apparatus for protecting and supporting an animal's leg and foot, comprising:
a protective boot comprising a legging member and a shoe member capable of being fitted over a hoof of the animal.

2. The apparatus of claim 1, wherein the animal is a livestock animal selected from the group consisting of: a horse, and a cow.

3. The apparatus of claim 1, wherein the protective boot comprises fabric.

4. The apparatus of claim 3, wherein the fabric comprises neoprene.

5. The apparatus of claim 1, wherein the legging member comprises a top portion, a bottom portion, a first edge, and a second edge opposite to the first edge.

6. The apparatus of claim 1, wherein the legging member and the shoe member are attached together by a fastener.

7. The apparatus of claim 1, wherein the legging member is detachable from the shoe member.

8. The apparatus of claim 5, wherein the top portion of the legging member comprises a first elastic band.

9. The apparatus of claim 5, wherein the bottom portion of the legging member comprises a second elastic band.

10. The apparatus of claim 5, wherein at least one of the first edge and the second edge comprises a fastener for connecting one edge to the other edge.

11. The apparatus of claim 10, wherein the fastener comprises at least one item selected from the group consisting of: a plurality of snap buttons, a zipper, hook-and-loop fasteners, and at least one buckle.

12. The apparatus of claim 1, wherein the shoe member comprises a material that is more rigid than a material from which the legging member is constructed.

13. The apparatus of claim 1, wherein the shoe member comprises a partially enclosed interior portion and a bottom portion.

14. The apparatus of claim 13, wherein the bottom portion of the shoe member comprises a cushion.

15. The apparatus of claim 14, wherein the cushion of the protective boot further comprises a gel pad.

16. The apparatus of claim 15, wherein the gel pad is shaped and sized to fit within a frog of a horse's hoof.

17. The apparatus of claim 1, wherein an inner surface of the protective boot comprises an insulative material.

18. The apparatus of claim 1, wherein an inner surface of the protective boot comprises a cushion material.

19. The apparatus of claim 18, wherein the cushion material comprises one or more items selected from the group consisting of: one or more air-filled bladders, one or more gel-filled bladders, one or more liquid-filled bladders, one or more inner layers of soft material attached to an inner surface of the legging member baffling, and baffling interconnected between an inner surface of the legging member and an layer of material connected to the inner surface of the legging member.

20. A method of protecting and supporting an animal leg and foot, the method comprising the steps of:
(a) inserting the foot of the animal into a shoe member;
(b) covering the leg of the animal with a legging member; and
(c) detachably connecting the legging member to the shoe member using a fastener.
